(19) United States
(12) Patent Application Publication
(10) Pub. No.: US 2007/0222921 A1
(43) Pub. Date: Sep. 27, 2007

(54) Electronic Device Having a Plurality of Electro-Optical Elements

(75) Inventors: Stephen I. Klink, Breda (NL); Dirk J. Broer, Geldrop (NL); Hjalmar E.A. Huitema, Veldhoven (NL); Joost P.A. Vogels, Leende (NL); Roel Penterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,700

(22) PCT Filed: Dec. 17, 2004
(86) PCT No.: PCT/IB04/52844

§ 371 Date: Feb. 22, 2007

(30) Foreign Application Priority Data
Dec. 27, 2003 (GB) 0330074.6

(51) Int. Cl. G02F 1/1343; G02F 1/1335

(52) U.S. Cl. 349/106; 349/139

(57) ABSTRACT

An electronic device (10) comprises a substrate (100) carrying a single electrode structure (120) and a plurality of electro-optical elements (140; 160, 180). The plurality of electro-optical elements (140, 160, 180) at least includes a first electro-optical element (140) covering a first part of the electrode structure (120), the first electro-optical element (140) comprising a first electrooptical material with a first transmission/voltage response characteristic and a second electro-optical element (160) covering a second part of the electrode structure (120), the second electro-optical element (160) comprising a second electro-optical material with a second transmission/vokage response characteristic. Consequently, the various electro-optical elements (140; 160 180) can be individually controlled with a single electrode structure by applying variable voltages.

The present invention relates to an electronic device having an electrode structure covered by a plurality of electro-optical elements.

Many electronic devices include a display for indicating a property of a signal relevant to the electronic device. For instance, the display of a mobile phone may include an indicator for indicating the strength of the received signal, a display of a recording device such as a compact cassette recorder may indicate the strength of the recorded signals on the respective stereo channels, and a display of an amplifier may show the strength of the stereo output signals.

Especially in application domains where such displays are dedicated displays, such displays typically include a plurality of electro-optical elements based on liquid crystal or light emitting diode materials, which are individually controlled to enable the signal dependent display characteristics. This requires a segmented electrode structure and a driver that controls each electrode segment, which adds to the cost of such electronic devices.

The present invention seeks to provide an electronic device according to the opening paragraph that can be controlled more simply.

This is realized by an electronic device comprising a substrate carrying a single electrode structure and a plurality of electro-optical elements at least including a first electro-optical element covering a first part of the electrode structure, the first electro-optical element comprising a first electro-optical material with a first transmission/voltage response characteristic; and a second electro-optical element covering a second part of the electrode structure, the second electro-optical element comprising a second electro-optical material with a second transmission/voltage response characteristic.

The present invention is based on the knowledge that nowadays techniques are available to deposit individual electro-optical elements on a substrate, for example by applying individual containers on a first substrate which are then filled with an electro-optical material e.g. a liquid crystal (for example by means of ink jet printing) and subsequently, covered with a second substrate. An other example is disclosed in non-prepublished UK patent application UK 0319908.0 with priority date 23/08/2003, in which droplets of a mixture of an electro-optical material and a polymer precursor are individually deposited by means of printing techniques such as ink-jet printing, after which the electro-optical elements are formed by forming a polymer topcoat from the polymer precursor over the electro-optical material in a so-called stratification step. This facilitates the deposition of electro-optical materials with different properties in different locations over the substrate. The present invention is based on the realization that this difference in property can be the transmission/voltage characteristic of the electro-optical material, i.e., the response characteristic of the material to an applied voltage. Consequently, the various electro-optical elements can be individually controlled with a single electrode structure by applying variable voltages, with such a voltage typically corresponding to an actual value of the signal property. This has the additional advantage that the driver circuitry for the electrode structure may be kept very simple, because a simple linear transformation of the signal to a corresponding voltage can suffice to drive the various electro-optical elements.

In an embodiment, the first electro optical-element further comprises a first polymer topcoat, the first electro-optical material being sandwiched between the first polymer topcoat and the substrate; and the second electro-element further comprises a second polymer topcoat, the second electro-optical material being sandwiched between the second polymer topcoat and the substrate. Such an electronic device can be produced by the printing method disclosed in non-prepublished UK patent application UK 0319908.0, which has the advantage that the electronic device can be produced at low cost. Also, because this is a single substrate technology and the processing temperatures of this method are modest, a plastic substrate may be used.

In a further embodiment, the first electro-optical material comprises a first liquid crystal material and the second electro-optical material comprises a second liquid crystal material. This is advantageous because the T/V characteristics of liquid crystal materials can easily be tuned by varying the composition of the liquid crystal mixture. The T/V characteristics of liquid crystal materials are well documented, and many known liquid crystal materials are commercially available, which makes it straightforward to compose a liquid crystal mixture with the desired T/V characteristics.

Depending on the nature of the LC material-related electro-optical effect, the electronic device may comprise a first light-polarizing layer and a second light-polarizing layer; the electro-optical elements being sandwiched between the first light-polarizing layer and the second light-polarizing layer in order to establish the desired light valve effect.

Advantageously, the first electro-optical element is covered by a first colour filter and the second electro-optical element is covered by a second colour filter. Hence, the colour appearance of the electronic device can be altered by varying the drive voltage applied to the single electrode structure.

The invention is described in more detail and by way of non-limiting examples with reference to the accompanying drawings, wherein:

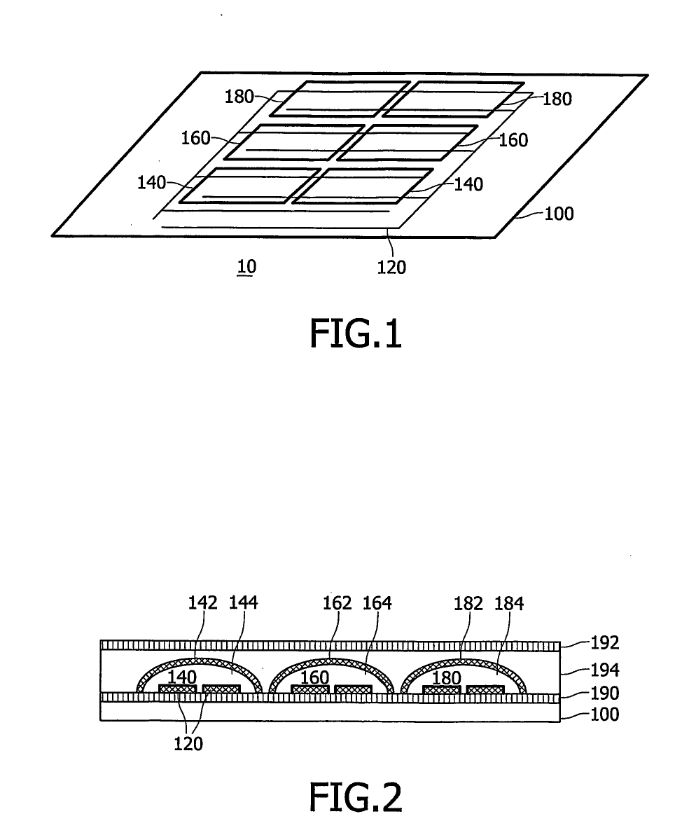

FIG. 1 depicts an embodiment of an electronic device of the present invention;

FIG. 2 depicts a side-view of an embodiment of an electronic device of the present invention;

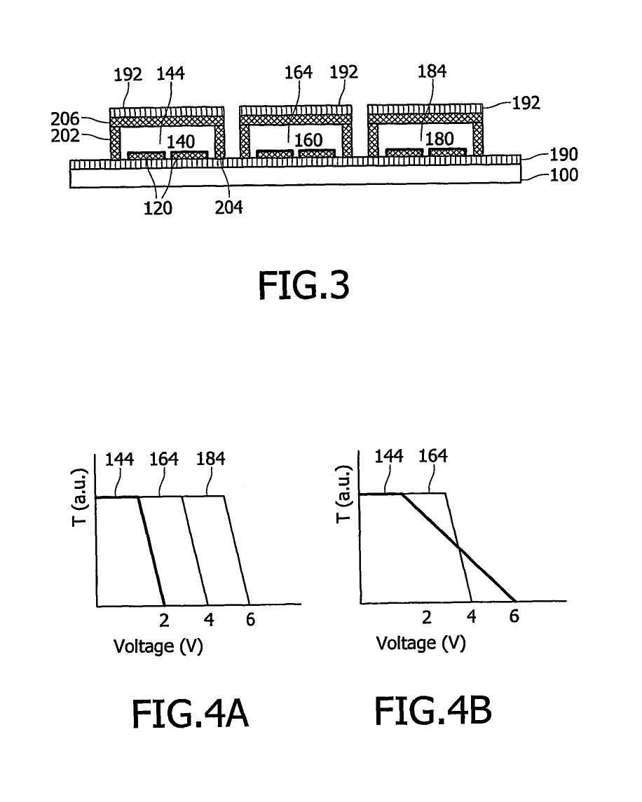

FIG. 3 depicts a side-view of another embodiment of an electronic device of the present invention and

FIG. 4 depicts examples of various T/V response curves of the electro-optical materials used in an electronic device of the present invention.

It should be understood that the Figures are merely schematic and are not drawn to scale. It should also be understood that the same reference numerals are used throughout the Figures to indicate the same or similar parts.

FIG. 1 shows an electronic device 10 of the present invention. The electronic device 10 has a substrate 100 carrying a single electrode structure 120. It is emphasized that in the context of the present invention, a single electrode structure is intended to mean an electrode structure that addresses all the electro-optical elements of the electronic device 10. The electrode structure 120 may be an interdigitated electrode structure, as shown in FIG. 1, or a top-bottom electrode structure without departing from the teachings of the present invention.

The substrate 100 is covered by a plurality of electro-optical elements 140, 160, 180, with two instances of an first electro-optical element 140 covering a first part of the electrode structure 120, the first electro-optical element 140 comprising a first electro-optical material with a first transmission/voltage response characteristic, two instances of a second electro-optical element 160 covering a second part of the electrode structure 120, the second electro-optical element 160 comprising a second electro-optical material with a second transmission/voltage response characteristic, and two instances of a third electro-optical element 180 covering a third part of the electrode structure 120, the third electro-optical element 160 comprising a third electro-optical material with a third transmission/voltage response characteristic.

It is emphasized that the electronic device 10 may further comprise well-known layers such as an alignment layer that is generally used in an LC-material based electronic device 10 or a light reflecting layer in case of a light-reflective electronic display device 10 or a light absorbing layer in the case of a light-reflective electronic display device 10 based on a light-reflective LC-effect (CTLC, Cholesteric Texture Liquid Crystal). Also, the different electro-optical elements 140, 160 and 180 may be covered by different colour filters (not shown) to create a multi-colour electronic device 10.

FIG. 2 shows a side view of an electronic device 10 of the present invention that has been produced using the production method described in non-prepublished UK patent application UK 0319908.0. The first electro-optical element 140 comprises a first polymer topcoat 142 and a first liquid crystal material 144 as an embodiment of the first electro-optical material; the second electro-optical element 160 comprises a second polymer topcoat 162 and a second liquid crystal material 164 as an embodiment of the second electro-optical material, and the third electro-optical element 180 comprises a third polymer topcoat 182 and a third liquid crystal material 184 as an embodiment of the third electro-optical material. In this embodiment, the substrate 100 also carries an alignment layer (not shown). In addition, the electronic device 10 comprises a first light-polarizing layer 190 and a second light-polarizing layer 194 sandwiched around the electro-optical elements 140, 160 and 180. The second light-polarizing layer 192 may be deposited directly on top of the various polymer topcoats 142, 162 and 182. Alternatively, a planarization layer 194 may be deposited over the various polymer topcoats 142, 162 and 182 prior to the deposition of the second light-polarizing layer 192 and an optional top electrode structure (not shown) in case of a top-bottom electrode arrangement.

A non-limiting example of the mixture of an electro-optical material and the polymer precursor to be deposited on the further layer is as follows:

50 weight percent (wt %) of a liquid crystal mixture, for instance the mixture E7, which is marketed by Merck, the liquid crystal mixture being an embodiment of the electro-optical material 112;

45 wt % photo-polymerizable isobornylmethacrylate (supplied by Sartomer);

4.5 wt % of a stilbene dimethacrylate dye:

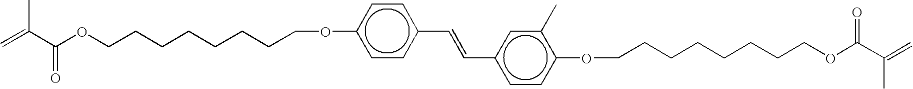

the synthesis of which has been disclosed in PCT patent application WO 02/42382 and which is hereby incorporated by reference, the two acrylates being an embodiment of the polymer precursor 114; and

0.5 wt % benzildimethylketal, which is marketed by Ciba-Geigy under the trade name Irgacure 651.

A non-limiting example of the printing process described in the non-prepublished UK patent application UK 0319908.0 is as follows. In a test setup, a 6×6 inch square glass substrate 100 carrying a number of interdigitated electrode structures 120 corresponding with the number of electronic devices 10 to be produced was provided a rubbed polyimide alignment layer Al3046 from the JSR electronics Company of Japan. The glass substrate 100 was mounted on a computer controlled X-Y table having a variable speed of 1-30 mm/s.

A MicroDrop inkjet printing device was placed in a fixed position over the X-Y table. The dispensing head of the MicroDrop inkjet printing device included a glass capillary shaped into a nozzle on one side, the capillary being surrounded by a tubular piezo-activator for generating a pressure wave through the capillary. The pressure wave triggers the release of a droplet of the first liquid from the capillary. A number of droplets may be deposited in the same location over the substrate to increase the size of the electro-optical element to be formed. This process was repeated for all various LC mixtures having different T/V characteristics. Consequently, the various droplets were exposed to UV light from a Philips TL08 UV lamp with a light intensity of 0.1 mW/cm² for 30 minutes at 40° C., after which the formation of the electro-optical elements 140, 160 and 180 was completed.

FIG. 3 shows a side-view of another embodiment of an electronic device 10 of the present invention based on known cell technology-based manufacturing technology. In this embodiment, the various electro-optical materials 144, 164 and 184 have been deposited in preformed containers, having sidewalls 202 and 203 and a lid 206. These containers may be formed by known lithographic methods. In FIG. 3, the containers have been depicted completely separated from each other, but it will be obvious to a skilled person that such a container may share a sidewall with a neighbouring container, in which case a single continuous lid 206 can be used. In case of the electro-optical materials 144, 164 and 184 being liquid crystal materials, a first light-polarizing layer 190 and a second light-polarizing layer 192 are also present in the electronic device 10.

At this point, it is emphasized that the present invention is not limited to signal indicating applications. Other applications for the electronic device 10 may include an electronic trademark, an electronic poster, an electronic billboard, an electronic roadsign and so on. For instance, the first electro-optical element 140 may be shaped in a first predefined form such as a figure holding the second electro-optical element 160 in the form of an umbrella, with the variation in driving voltage being used to switch on and off the umbrella. The third electro-optical element 180 may be shaped in the form of a raincloud to further enhance the billboard or poster. Further electro-optical elements may be added to create more complex designs. Alternatively, the electro-optical element 140 may be shaped in the form of a first text and the second electro-optical element 160 may be shaped in the form of a second text. Many other examples can be easily thought of.

The electronic device 10 may also be an electronic wallpaper, with the first electro-optical element 140 being covered by a first colour filter, the second electro-optical element 160 being covered by a second colour filter and the third electro-optical element 180 being covered by a third colour filter, with a variation in driving voltage creating a different ambiance in a room having walls covered by the electronic wallpaper. It is emphasized that the present invention can be particularly advantageous for such applications, because a simple, single electrode structure 120 is sufficient to control multiple electro-optical elements covering a large area.

A possible mode of operation of the electronic device 10 of the present invention will be explained with the aid of the graphs depicted in FIG. 4 in back reference to the previous figures. These graphs are typical for example for a Twisted Nematic LC-mode between crossed polarizers (normally white mode). Referring to FIG. 4a, at a voltage V=0V, all three electro-optical materials 144, 164 and 18 are in a transmissive state (normally white mode). Now, with an increase in for instance a signal strength, the voltage across the electrode structure 120 will increase correspondingly. At approximately V=1V, the first electro-optical material 144 will become responsive to the applied voltage, and at V=2V, the first electro-optical material 144 will have switched from a transmissive to a non-transmissive state.

With a further increase in signal strength, the second electro-optical material 164 will become responsive to the applied voltage at approximately V=3V, and at V=4V, the second electro-optical material 164 will have switched from a transmissive to a non-transmissive state

With yet a further increase in signal strength, the third electro-optical material 184 will become responsive to the applied voltage at approximately V=5V, and at V=6V, the third electro-optical material 184 will have switched from a transmissive to a non-transmissive state. Obviously, the inverse behaviour, i.e., electro-optical elements 140, 160, 180 becoming transmissive with increasing voltage across the electrode structure 120 is equally feasible, for example by providing the device with parallel polarizers (normally black mode). When the device is provided with a light-reflecting layer the elements can be switched from a reflective bright state to a non-reflective state dark state, or from a non-reflective dark state to reflective bright state.

Also, as shown in FIG. 4b, the slope of the T/V curve may vary between the various electro-optical materials, which can be used to tune the grey scale behaviour of the various electro-optical elements. Here, second electro-optical material 164 has a much steeper slope than first electro-optical material 144. Consequently, the second electro-optical element 180 a much smaller voltage interval in which the second electro-optical element 180 will have a grey appearance compared to the much wider grey scale interval for the first electro-optical element 160.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An electronic device (10) comprising:
a substrate (100) carrying a single electrode structure (120); and
a plurality of electro-optical elements (140; 160, 180) at least including:
a first electro-optical element (140) covering a first part of the electrode structure (120), the first electro-optical element (140) comprising a first electro-optical material (144) with a first transmission/voltage response characteristic; and
a second electro-optical element (160) covering a second part of the electrode structure (120), the second electro-optical element (160) comprising a second electro-optical material (164) with a second transmission/voltage response characteristic.

2. An electronic device (10) as claimed in claim 1, wherein:
the first electro-optical element (140) further comprises a first polymer topcoat (142), the first electro-optical material (144) being sandwiched between the first polymer topcoat (142) and the substrate (100); and
the second electro-optical element (160) further comprises a second polymer topcoat (162), the second electro-optical material (164) being sandwiched between the second polymer topcoat (162) and the substrate (100).

3. An electronic device (10) as claimed in claim 1, wherein the first electro-optical material (144) comprises a first liquid crystal material and the second electro-optical material (164) comprises a second liquid crystal material.

4. An electronic device (10) as claimed in claim 3, the electronic device (10) further comprising a first light-polarizing layer (190) and a second light-polarizing layer (192); the electro-optical elements (140; 160, 180) being sandwiched between the first light-polarizing layer (190) and the second light-polarizing layer (192).

5. An electronic device as claimed in claim 1, wherein the first electro-optical element (140) is covered by a first colour filter and the second electro-optical element (160) is covered by a second colour filter.
